(19) United States
(12) Patent Application Publication
(10) Pub. No.: US 2008/0032629 A1
(43) Pub. Date: Feb. 7, 2008

(54) Bluetooth internet phone and wireless apparatus thereof

(75) Inventors: Chien-Wei Wang, Taoyuan Hsien (TW); Chiu-Lin Chuang, Taoyuan Hsien (TW); Chih-Hung Chiu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/812,734

(22) Filed: Jun. 21, 2007

(30) Foreign Application Priority Data
Aug. 2, 2006 (TW) 095128338

(51) Int. Cl. H04B 7/00

(52) U.S. Cl. 455/41.2

(57) ABSTRACT

A Bluetooth internet phone includes a Bluetooth wireless apparatus and a computing machine which is cooperated with the Bluetooth wireless apparatus and is connected with Internet. The computing machine includes a Bluetooth communicating module and a Voice over Internet Protocol (VoIP) module. The Bluetooth wireless apparatus includes a Bluetooth transceiver module and a Handsfree Profile (HFP) module. The HFP module is able to transmit audio signals and data signals under a Handsfree Profile, wherein the audio signals and the data signals are transmitted to the computing machine through the Bluetooth transceiver module and are transferred into an information packet through the VoIP module to be transmitted to Internet.

### CROSS REFERENCE TO RELATED APPLICATIONS

This Non-provisional application claims priority under 35 U.S.C. §119(a) on Patent Application No(s). 095128338 filed in Taiwan, Republic of China on Aug. 2, 2006, the entire contents of which are hereby incorporated by reference.

### BACKGROUND OF THE INVENTION

1. Field of Invention

The present invention relates to an application of Bluetooth wireless communication technique, and more particularly to a Bluetooth internet phone.

2. Related Art

As the internet audio software, Skype, had been come to the present market, there are millions of users of it. Because Skype is a free software and wide band network is available to all, the cost of internet phone by Skype is much cheaper than by Public Switched Telephone Network (PSTN). Skype utilizes Voice on Internet Protocol (VoIP) technique to code an audio signal into a digital signal, and then compress and packet it, for transmission on internet. The digital signal is decoded back to an analog signal when it is transmitted to the destination so that the audio communication is constructed.

The Skype program is usually installed on a computer connected with a wire earphone and microphone so that user may dial a telephone number through the computer to make an internet phone call. There are many internet phones in the present market made like a common phone, such as USB phone. The USB phone, which is connected with the computer via USB interface, provides user a conventional way to make a phone call. That is, user can directly dial on the USB phone, and the dialing number is transmitted to the Skype program in the computer for an internet phone call. However, a wireless apparatus is more convenient than a wire apparatus so that Bluetooth internet phone comes to market. The Bluetooth internet phone utilizes Bluetooth communication technique to be communicated with the Skype program in the computer.

Basically, Bluetooth communication technique is a short distance wireless communication technique for substituting for wire transmission and Infrared Data Association (IRDA) which has a shortest communicating distance and a poor penetrability. The radio frequency of Bluetooth utilizes the bandwidth between 2.4 GHz and 2.497 GHz of Industrial Scientific Medical (ISM). Although there are still any other wireless communication apparatuses can be used, Bluetooth communication technique utilizes Frequency-Hopping-Spread-Spectrum (FHSS) technique, which has changing channels of 1,600 Hz so as to bar the interference from other wireless signals. In addition, Bluetooth communication technique has many further advantages, such as lower cost, lower power, multiple links, and transmission of audio signals and data signals in the same time, so that it has become a major technique of short distance wireless communication.

Except for many protocols which Bluetooth communication technique has to obey, Bluetooth communication technique further develops many Profiles in these Protocols to achieve many applications and functions of user mode, such as Advanced Audio Distribution Profile (A2DP) which describes how a multimedia transmitter, such as a MP3 player, transmits an audio signal of stereo level to a receiver, such as a Bluetooth earphone, Headset Profile (HSP) which describes how a Bluetooth enabled earphone communicates a computer or other Bluetooth enabled terminal apparatuses, such as a cellular phone, and Serial Port Profile (SPP) which defines how to build a virtual serial port between two Bluetooth enabled electronic apparatuses to replace the conventional RS-232 wire serial transmission interface.

Now a Bluetooth internet phone for how the Bluetooth communication technique working is described herein below. As shown in FIG. 1, a conventional Bluetooth internet phone 5 includes a Bluetooth wireless phone set 1 communicated with a computer 2 which are cooperated with each other. The Bluetooth wireless phone set 1 includes a Bluetooth communicating module 11, a microcontroller unit (MCU) 12 and a memory 13. The Bluetooth communicating module 11 and the memory 13 are electrically connected with the microcontroller unit 12, respectively. In addition, the Bluetooth wireless phone set 1 enables Headset Profile (HSP). The Bluetooth communicating module 11 includes a Headset Profile (HSP) module 111, a Serial Port Profile (SPP) module 112 and a Bluetooth transceiver module 113, in which the HSP module 111 transmits audio signals, the SPP module 112 transmits data signals, and the Bluetooth transceiver module 113 transmits and receives signals.

The computer 2 is equipped with a Bluetooth communicating module 21 so as to enable Bluetooth communication technique. The computer 2 is further equipped with a Skype module 22 for transferring an audio signal into an Internet Protocol (IP) information packet and transmitting it to Internet, here is presented as “INT”. In addition, the computer 2 is further equipped with an intermedium module 23 for communication between the HSP module 111 of the Bluetooth wireless phone set 1 and the Skype module 22 of the computer 2.

Bluetooth communication technique defines two sides of communication as master and slayer and three operation modes, inquiry, page and link to complete the link. Typically, the Bluetooth wireless phone set 1 is the slayer, and the computer 2 is the master. In inquiry, the master gets time and address of the slayer. In page, the slayer gets time and address of the master to achieve synchronization and gets the same frequency hopping sequence that the Bluetooth wireless phone set 1 and the computer 2 may take frequency hoping procedures synchronously. At last, some communication protocols in link are built so that the Bluetooth wireless phone set 1 and the computer 2 are in connection to process the essential Profiles.

Under the definition of the Headset Profile, the Bluetooth wireless phone set 1 may start or terminate a communication by the HSP module 111. That is, the Bluetooth wireless phone set 1 may start or terminate the communication when the Skype module 22 of the computer 2 receives a call from Internet “INT”. On the other hand, when user dials on the Bluetooth wireless phone set 1, the information concerning to dialing numbers is transmitted by the SPP module 112 and modulated by the Bluetooth transceiver module 113, and then the signal is transmitted to the Bluetooth communicating module 21 of the computer 2 for demodulation. After that, the intermedium module 23 calls an application programming interface (API) of the Skype module 22 according to the dialing numbers for dialing.

In addition, when the Bluetooth wireless phone set 1 searching in the address book in the Skype module 22, the address book is transmitted through the SPP module 112 and is saved in the memory 13. Generally speaking, in the Bluetooth internet phone 5, HSP module 111 takes charge of the audio signal transmission, the SPP module 112 takes charge of the data signal transmission, and the microcontroller unit 12 controls the HSP module 111 and the SPP module 112.

Although the Bluetooth internet phone 5 respectively provides the HSP module 111 and the SPP module 112 in charge of transmissions of audio signals and data signals, it affects the quality of transmission and increases the time and difficulty of development of using the microcontroller unit 12 to control these two Profiles on condition that theses two Profiles transmit signals synchronously. In addition, the Bluetooth wireless phone set 1 has to perform update procedure when starts the computer 2, which means the computer 2 updates the address book to the Bluetooth wireless phone set 1 and saves it in the memory 13 that prolongs the starting time and increase the cost because of the memory 13.

It is therefore an important subject to provide a Bluetooth internet phone which can shorten the developing time, decrease the production cost and enhance the transmission quality to raise overall performance.

### SUMMARY OF THE INVENTION

In view of the foregoing, the present invention is to provide a Bluetooth internet phone under a Handsfree Profile to synchronously transmit audio signals and data signals, which can shorten the developing time, decrease the production cost and enhance the transmission quality to raise overall performance.

To achieve the above, a Bluetooth internet phone according to the present invention includes a Bluetooth wireless apparatus and a computing machine which is connected with Internet. The computing machine includes a Bluetooth communicating apparatus and a Voice over Internet Protocol (VoIP) module. The Bluetooth wireless apparatus includes a Bluetooth transceiver module and a Handsfree Profile (HFP) module. The HFP module is able to transmit audio signals and data signals to the Bluetooth communicating apparatus of the computing machine through the Bluetooth transceiver module. The VoIP module transfers the audio signals and data signals into an information packet and then transmits the information packet to the internet.

Furthermore, under the Handsfree Profile, the Bluetooth internet phone can control the VoIP module of the computing machine through AT commands under the Handsfree Profile and self-defined extending AT commands of the present invention to transmit the data signals, such as operation modes. Compared to the prior art, the present invention utilizes only one single Profile for transmission that shortens the developing time and lowers the production cost. Also, the transmitted signal will not be interfered.

In addition, the operation of the Bluetooth wireless apparatus for the VoIP module can be designated to directly operate the VoIP module of the computing machine so that a command of the Bluetooth wireless apparatus will be transmitted to the VoIP module through the Handsfree Profile first, and then take the corresponding action so that there is no need to download the essential data of the VoIP module to the Bluetooth wireless apparatus. As the results, additional memory to store large amount of data can be economically saved, and it can shorten the time of starting machine and lower the production cost. The Bluetooth internet phone of the present invention can thus shorten the developing time, decrease the production cost and enhance the transmission quality to raise overall performance.

### BRIEF DESCRIPTION OF THE DRAWINGS

The invention will become more fully understood from the detailed description given hereinbelow illustration only, and thus is not limitative of the present invention, and wherein:

FIG. 1 is a schematic diagram showing a conventional Bluetooth internet phone;

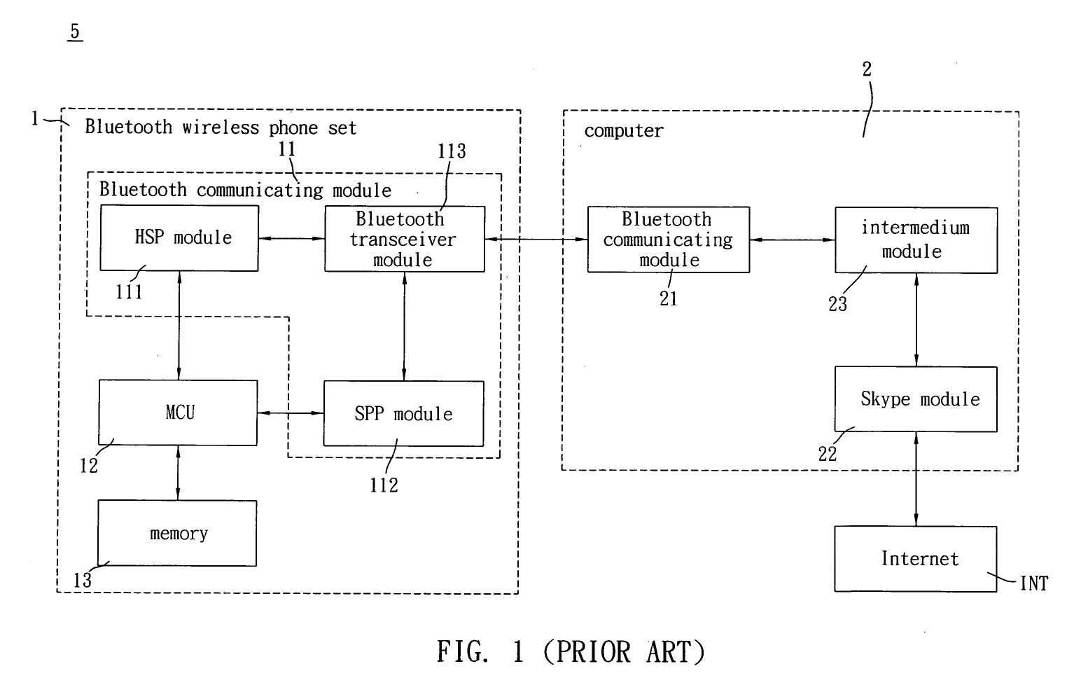

FIG. 2 is a schematic diagram showing a Bluetooth internet phone according to an embodiment of the present invention;

FIG. 3 is a schematic diagram showing the Bluetooth internet phone of FIG. 2; and

FIG. 4 is a schematic diagram showing the Bluetooth internet phone of FIG. 2 executing AT commands.

### DETAILED DESCRIPTION OF THE INVENTION

The present invention will be apparent from the following detailed description, which proceeds with reference to the accompanying drawings, wherein the same references relate to the same elements.

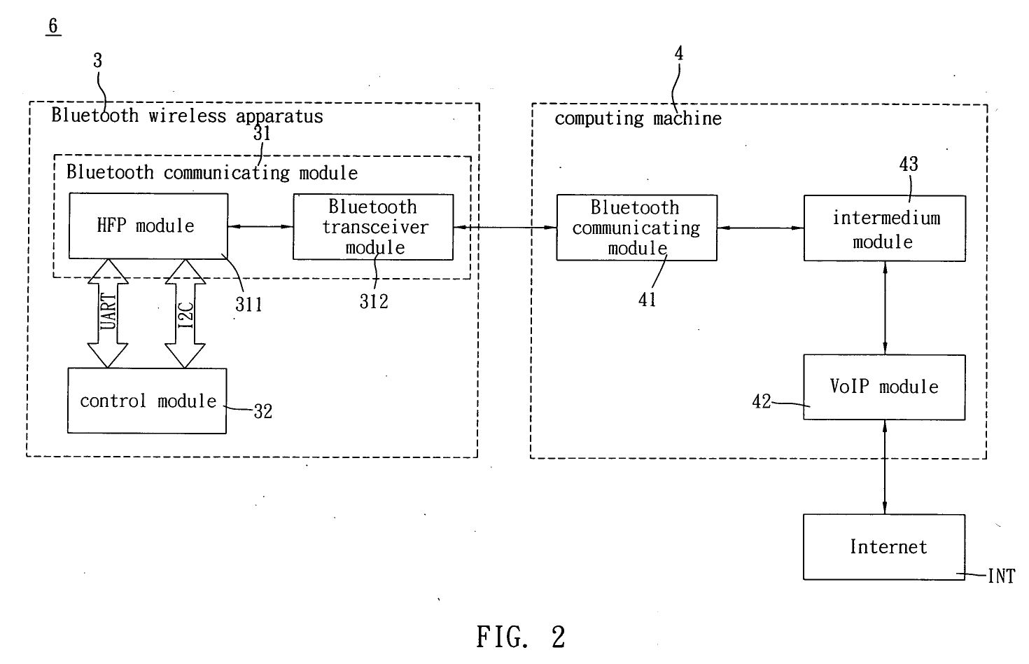

As shown in FIG. 2, a Bluetooth internet phone 6 according to an embodiment of the present invention includes a Bluetooth wireless apparatus 3 and a computing machine 4, both of which are cooperated with each other. The Bluetooth wireless apparatus 3 includes a Bluetooth communicating module 31, which enables a Handsfree Profile, and a control module 32. The Bluetooth communicating module 31 includes a Handsfree Profile (HFP) module 311 and a Bluetooth transceiver module 312. The HFP module 311 is electrically connected with the control module 32. Signals transmitted between the HFP module 311 and the control module 32 by either a universal asynchronous receiver/transmitter (UART) or an inter-integrated circuit (I2C) Bus or by both of them.

In this embodiment, the Bluetooth communicating module 31 is constructed by a base band circuit and a radio frequency circuit. The base band circuit takes charge of building and removal of connection, coding the signal, packet processing and frequency hopping control. The radio frequency circuit takes charge of integration of carrier wave and transmitting/receiving the signals. The Bluetooth communicating module 31 of this embodiment is operated on a class 2 operating distance, which is 10 m, with a power about 1 mW. In addition, the control module 32 mainly includes a microcontroller unit (MCU).

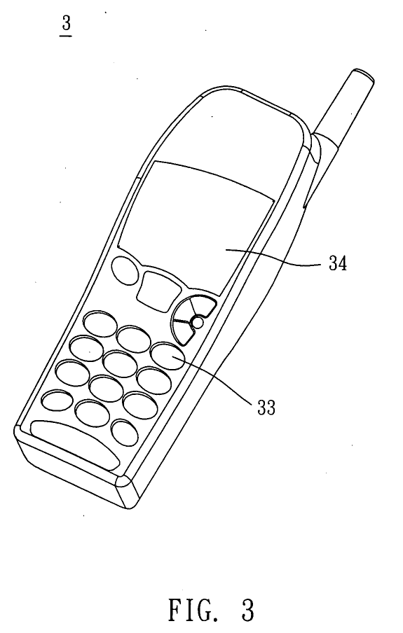

As shown in FIG. 3, the Bluetooth wireless apparatus 3 further includes a plurality of keys 33 and a flat display module 34. The flat display module 34 may be a liquid crystal display (LCD) module, an organic electroluminescent display (OELD) module or a light emitting diode (LED) display module.

As shown in FIG. 2, the computing machine 4, which enables Bluetooth communication technique, includes a Bluetooth communicating module 41, a Voice over Internet Protocol (VoIP) module 42 and an intermedium module 43. The VoIP module 42 transfers an audio signal into an information packet of Internet Protocol (IP) and transmits it to Internet “INT”. The intermedium module 43 takes charge of the communication between the HFP module 311 of the Bluetooth wireless apparatus 3 and the VoIP module 42 of the computing machine 4. The computing machine 4 may be an electronic apparatus capable of connecting with the internet INT, such as a notebook computer or a desktop computer. The VoIP module 42 may be a program with VoIP technique, such as Skype program, Google Talk program, MSN program, Yahoo Messenger program, or others programs with VoIP technique.

The Bluetooth wireless apparatus 3 and the computing machine 4 have to connect with each other before data transmission. The Bluetooth wireless apparatus 3 is the slayer and the computing machine 4 is the master. After the procedures of inquiry, page and link, the connection of the Bluetooth wireless apparatus 3 and the computing machine 4 is achieved and data transmission is performed under the Handsfree Profile.

In Bluetooth communication technique, the Handsfree Profile describes how a hands-free apparatus enabling Bluetooth communicates with the other terminal apparatus enabling Bluetooth. In this embodiment, the Bluetooth wireless apparatus 3 is a hands-free apparatus, and the computing machine 4 is a terminal apparatus. The Handsftee Profile includes AT command set to enable the Bluetooth wireless apparatus 3 making corresponding request to the computing machine 4 according to the AT commands.

Typically, an AT command carries only one command, and when the receiving end receives an AT command, it generates a response including OK, error or result codes, wherein “OK” represents that the receiving end takes normal operation according to the AT command, and “error” represents that the receiving end does not operate according to the AT command. For example, when the VoIP module 42 receives a call from Internet “INT”, the intermedium module 43 transmits an alarm signal to the Bluetooth wireless apparatus 3 through the Bluetooth communicating module 41. The Bluetooth wireless apparatus 3 receives the alarm signal and generates a phone ring (the intermedium module 43 also may not transmitting the alarm signal and the computing machine 4 generating the phone ring directly). If user doesn't want to answer the call, he/she may press the refuse key (one of the keys 33) that the control module 32 commands the HFP module 311 to transmit a refusing AT command, whose syntax is “AT+CHUP”. When the VoIP module 42 receives the AT command, the intermedium module 43 will call a corresponding function of an application program interface (API) of the VoIP module 42 according to the AT command to cut off communication that may refuse the call.

On the other hand, the Bluetooth communicating module 41 transmits a “OK” signal back to the Bluetooth wireless apparatus 3, and then transmits a result code “+CIEV:(callsetup=0)” back to the Bluetooth wireless apparatus 3, which represents an operation mode of no call. The operation mode may be transmitted to the control module 32 by a Universal Asynchronous Receiver Transmitter (UART) to control the flat display module 34 showing the corresponding message.

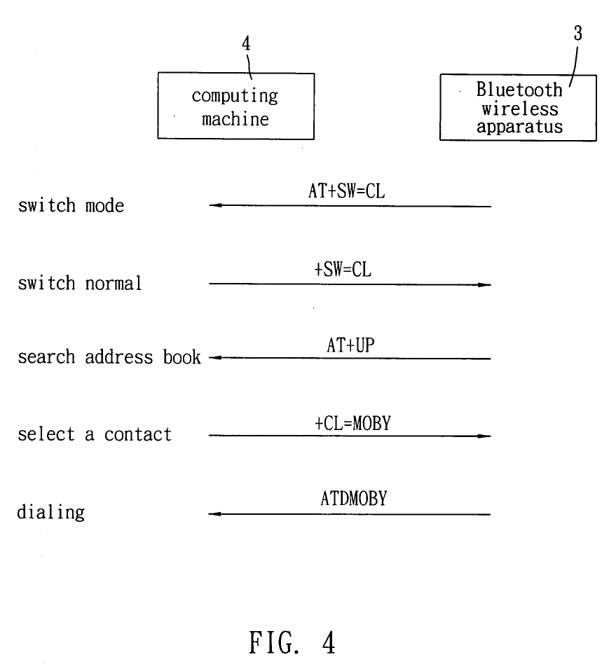

In this embodiment, the Bluetooth wireless apparatus 3 not only can utilize the same AT commands in the original Handsfree Profile, but also can define some extending AT commands to operate some functions, which are originally operated on the computing machine 4, through the Bluetooth wireless apparatus 3 so as to facilitate user for operation. For example, as shown in FIG. 4, if the VoIP module 42 originally has the functions of searching the address book and dialing the chosen number, the operation includes the following steps. Firstly, a user presses one of the keys 33 to command HFP module 311 transmitting a self-defined extending AT command requested by a switch mode to the computing machine 4 through the Bluetooth transceiver module 312. The syntax is for example “AT+SW=CL”. The intermedium module 43 calls the VoIP module 42 entering the switch mode according to the self-defined extending AT command that the VoIP module 42 will open the address book. On the other hand, the Bluetooth communicating module 41 transmits a result code, such as “+SW=CL”, back to the Bluetooth wireless apparatus 3 to represent normal function. The flat display module 34 may show this message on screen to inform user. Next, the user may press the arrow key of the keys 33 to switch the contacts. For example, when the user presses “Up” key, the HFP module 311 transmits a self-defined extending AT command according to the request to the computing machine 4. The syntax is for example “AT+UP”. The intermedium module 43 calls the corresponding functions of the API of the VoIP module 42 to find the contact information. In the same time, the Bluetooth communicating module 41 transmits a result code, such as “+CL=MOBY”, back to the Bluetooth wireless apparatus 3. The result code will include the information of the contact to be transmitted to the control module 32 via the inter-integrated circuit (I2C) bus and show the information on the flat display module 34. When the user find the desired contact, he/she may press the dialing key, and the HFP module 311 will transmits a dialing AT command, whose syntax is “ATDMOBY”, and the intermedium module 43 calls the corresponding functions of the API of the VoIP module 42 to dial the number.

Of course, the self-defined extending AT commands are not limited in the functions as described above. Any function in the VoIP module 42 that may be operated in the computing machine 4 can be operated in the Bluetooth wireless apparatus 3 by the self-defined extending AT commands, such as triple communication, refusing the call, redialing and call forwarding. The Bluetooth internet phone 6 of the present invention can transmit audio signals and data signals in the same protocol.

In summary, the Bluetooth internet phone of the present invention enables Handsfree Profile. Under the definition of Handsfree Profile, the Bluetooth internet phone includes the Bluetooth wireless apparatus and the computing machine enabling Bluetooth communication technique for connection and transmission of audio message. It also can transmit data, once for a data, by the AT commands and the self-defined extending AT commands under the Handsfree Profile. Compared to the prior art, the present invention utilizes only one Profile for transmission that shortens the developing time and lowers the production cost. Furthermore, the transmitted signal will not be interfered. In addition, the characteristic of once transmitting a data can shorten the time of start and shut down the machine, and the present invention doesn't need additional memory to store large amount of data that economically saves the production cost. The Bluetooth internet phone of the present invention can thus shorten the developing time, decrease the production cost and enhance the transmission quality to raise overall performance.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A Bluetooth wireless apparatus, cooperated with a computing machine having a Voice over Internet Protocol (VoIP) module, comprising:
a Bluetooth transceiver module; and
a Handsfree Profile (HFP) module transmitting audio signals and data signals under a Handsfree Profile, wherein the audio signals and the data signals are transmitted to the computing machine through the Bluetooth transceiver module and are transferred into an information packet through the VoIP module to be transmitted to Internet.

2. The Bluetooth wireless apparatus according to claim 1, wherein the Handsfree Profile comprises AT commands and self-defined extending AT commands for transmitting the data signals.

3. The Bluetooth wireless apparatus according to claim 2, wherein the computing machine further comprises a Bluetooth communicating module and an intermedium module, the Bluetooth communicating module and the Bluetooth transceiver module transmit and receive signals, and the intermedium module is electrically connected with the Bluetooth communicating module for receiving the AT commands and self-defined extending AT commands and calling the VoIP module in accordance with the AT commands and the self-defined extending AT commands.

4. The Bluetooth wireless apparatus according to claim 3, wherein the VoIP module receives a call from the internet and transmits an alarm signal through the intermedium module that the alarm signal is transmitted to the Bluetooth wireless apparatus through the Bluetooth communicating module for generating a phone ring from the Bluetooth wireless apparatus; or the VoIP module receives a call from Internet, and the computing machine generates a phone ring.

5. The Bluetooth wireless apparatus according to claim 3, wherein the AT commands and the self-defined extending AT commands comprise functions of answer, hung-up, searching an address book, switching mode, triple communication, refusing, redialing, call forwarding or dialing.

6. The Bluetooth wireless apparatus according to claim 1, further comprising a flat display module, such as a liquid crystal display (LCD) module, an organic electroluminescent display (OELD) module or a light emitting diode (LED) display module.

7. The Bluetooth wireless apparatus according to claim 1, further comprising a plurality of keys for controlling signal transmission between the Bluetooth wireless apparatus and the computing machine.

8. The Bluetooth wireless apparatus according to claim 1, wherein the VoIP module comprises a program with VoIP technique.

9. The Bluetooth wireless apparatus according to claim 1, further comprising a control module, such as a microcontroller unit (MCU), electrically connected with the HFP module.

10. The Bluetooth wireless apparatus according to claim 9, wherein the control module and the HFP module transmit signals by a universal asynchronous receiver/transmitter (UART) or by an inter-integrated circuit (I2C) Bus.

11. The Bluetooth wireless apparatus according to claim 1, further comprising a base band circuit and a radio frequency circuit, wherein the base band circuit takes charge of building and removal of connection, coding the signals, packet processing and frequency hopping control, and the radio frequency circuit takes charge of integration of carrier waves and transmitting/receiving the signals.

12. A Bluetooth internet phone, comprising:
a Bluetooth wireless apparatus comprising:
a Bluetooth transceiver module;
a Handsfree Profile (HFP) module transmitting audio signals and data signals to the Bluetooth transceiver module under a Handsfree Profile; and
a control module electrically connected with the Bluetooth transceiver module for transmitting and receiving signals; and
a computing machine comprising:
a Bluetooth communicating module transmitting and receiving the signals with the Bluetooth transceiver module;
an intermedium module electrically connected with the Bluetooth communicating module for transferring and transmitting signal; and
a Voice over Internet Protocol (VoIP) module electrically connected with the intermedium module and connected with Internet.

13. The Bluetooth internet phone according to claim 12, wherein the Handsfree Profile comprises AT commands and self-defined extending AT commands for transmitting the data signals, and the intermedium module receives the AT commands and the self-defined extending AT commands and calls application program interface (API) of the VoIP module in accordance with the AT commands and the self-defined extending AT commands.

14. The Bluetooth internet phone according to claim 13, wherein the VoIP module receives a call from Internet and transmits an alarm signal through the intermedium module that the alarm signal is transmitted to the Bluetooth wireless apparatus through the Bluetooth communicating module for generating a phone ring on the Bluetooth wireless apparatus.

15. The Bluetooth internet phone according to claim 13, wherein the VoIP module receives a call from Internet, and the computing machine generates a phone ring.

16. The Bluetooth internet phone according to claim 13, wherein the AT commands and the self-defined extending AT commands comprise functions of answer, hung-up, searching an address book, switching mode, triple communication, refusing, redialing, call forwarding or dialing.

17. The Bluetooth internet phone according to claim 13, wherein the Bluetooth wireless apparatus further comprises a flat display module, such as a liquid crystal display (LCD) module, an organic electroluminescent display (OELD) module or a light emitting diode (LED) display module.

18. The Bluetooth internet phone according to claim 13, wherein the Bluetooth wireless apparatus further comprises a plurality of keys for controlling the signal transmission between the Bluetooth wireless apparatus and the computing machine, and the VoIP module comprises a program with VoIP technique.

19. The Bluetooth internet phone according to claim 12, wherein the control module, such as a microcontroller unit (MCU), and the HFP module transmit signals by a universal asynchronous receiver/transmitter (UART) or by an inter-integrated circuit (I2C) Bus.

20. The Bluetooth internet phone according to claim 12, wherein the Bluetooth wireless apparatus further comprises a base band circuit and a radio frequency circuit, the base band circuit takes charge of building and removal of connection, coding the signals, packet processing and frequency hopping control, and the radio frequency circuit takes charge of integration of carrier waves and transmitting/receiving the signals.
